(19) United States
(12) Patent Application Publication
(10) Pub. No.: US 2010/0068021 A1
(43) Pub. Date: Mar. 18, 2010

(54) Combination Seed or Grain Carrier

(75) Inventors: Brian James Petersen, Ottawa, OH (US); David Richard Smith, Fort Jennings, OH (US)

Correspondence Address: ROTHWELL, FIGG, ERNST & MANBECK, P.C., 1425 K STREET, N.W., SUITE 800, WASHINGTON, DC, 20005, US

(73) Assignee: Unverferth Manufacturing Company, Inc., Kalida, OH (US)

(21) Appl. No.: 12/554,740

(22) Filed: Sep. 4, 2009

Related U.S. Application Data
(63) Continuation-in-part of application No. 12/031,867, filed on Feb. 15, 2008.
(60) Provisional application No. 60/901,321, filed on Feb. 15, 2007.

(51) Int. Cl. B60P 1/36

(52) U.S. Cl. 414/523

(57) ABSTRACT

A combination seed carrier for carrying a plurality of disparate seed containers includes a having a base and a common or central hopper. The common frame supports the common hopper over a base. The base includes means for being fixed to a transport device. The common hopper includes a plurality of inwardly facing inclined walls for channeling seed to a discharge area and fixtures positioned on the walls for fixedly receiving a plurality of disparate seed containers such that seed can be discharged from the seed containers into the common hopper. The seed carrier further includes a conveyor having an intake and a discharge. The conveyor is pivotably coupled to the common frame such that the intake can be positioned below the common hopper output for receiving seed from the common hopper.

### CROSS-REFERENCE TO RELATED APPLICATION

This application is a continuation-in-part of U.S. patent application Ser. No. 12/031,867 filed on Feb. 15, 2008, the entire disclosure of which is incorporated herein by reference, which claimed the benefit of priority to U.S. Provisional Application Ser. No. 60/901,321 filed on Feb. 15, 2007, the entire disclosure of which is incorporated herein by reference.

### BACKGROUND OF THE INVENTION

1. Field of the Invention

The present invention relates generally to farm implements, and more particularly to grain and seed carriers. Even more particularly, the present invention relates to a bulk seed carrier capable having a common hopper capable of receiving a plurality of seed containers or hoppers of disparate designs.

2. Description of the Related Art

Seed and grain is sold and transported in bulk. Seed and grain can be pre-packaged or loaded in bulk onto a wagon or trailer. Seed or grain can be sold in a number of different prepackaged containers. Each type of container typically requires specialized frames for transporting. For example, bulk tanks are used to carry large quantities of a seed, grain or any other material in a single tank. Bulk tanks are generally loaded with bags of material, such as seed, grain or corn. Bulk tanks typically use a bulk tank frame. Another known prepackaging is called a pro box. Pro boxes are loaded with the material by the manufacturer or vendor and are purchased fully loaded by the consumer. In general, pro box frames are designed to support more than one pro box. At present, different frames are required for transporting different grain or seed containers. This gives rise to a number of problems.

First, the manufacturer and/or seller must carry a unique seed carrier frame for each type of bulk seed container or packaging. The manufacturing costs become higher because each seed carrier frame produced must be different. The inventory costs are higher because a different frame must be carried for each style of container.

Second, customers are only able to purchase one specific type of container for each carrier frame that they own. The customer is required to purchase a different frame for each container design. The various container designs have unique benefits that a customer may wish to take advantage of when handling different seeds or grains. For example, if a customer owns seed carrier or wagon having a bulk hopper, he or she is unable able to purchase seed in pro boxes and transport the seed without first discharging the seed from the pro-boxes into the bulk hopper.

Therefore, a need exists for new and improved seed carriers that are configured to receive for transport a plurality of different seed container designs to be carried by or coupled to a common frame. Preferably, the new and improved seed carriers include a single frame with a common hopper that can be coupled to various seed containers such as to reduce production and inventory costs as well as provide customers with the ability to use different types of seed containers a single frame.

### SUMMARY OF THE INVENTION

According to an embodiment of the present invention, a combination seed carrier for carrying a plurality of disparate seed containers includes a common frame capable of supporting a common hopper over a base. The common hopper includes a plurality of inwardly facing inclined walls for channeling material to a discharge area or sump, and further includes fixtures positioned on the walls for removeably fixing a plurality of different seed containers such that seed can be discharged from the containers into the common hopper. The seed carrier further includes a conveyor having an intake and a discharge end. The conveyor is pivotably coupled to the common frame such that the intake can be positioned below the discharge area of the common hopper for receiving seed from the common hopper, which can in turn, be moved through the conveyor.

According to another embodiment of the present invention, the containers can be any one of a pro-box, a bulk tank or a bulk hopper. According to a further embodiment of the present invention, the common hopper is configured to receive four pro-boxes.

According to another embodiment of the present invention, the common hopper is configured also to receive a bulk tank that includes a circumferential frame capable of being coupled to the common hopper.

According to another embodiment of the present invention, the common hopper further includes a divider spanning between two of the inwardly facing inclined walls. According to another embodiment of the present invention, the common hopper further includes at least one support member for coupling the common hopper and the base. According to another embodiment of the present invention, the common frame further includes a weigh system capable of determining the weight of the main hopper.

According to another embodiment of the present invention, the common hopper further includes a tubular frame fixed to the top of the common hopper, wherein the tubular frame is capable of receiving a plurality of seed containers.

According to another embodiment of the present invention, the seed carrier includes a power system for supplying power to the conveyor. The power system may include a generator. According to another embodiment of the present invention, the conveyor includes a continuous flexible belt coupled to a first and second roller and a tubular portion disposed between said intake and discharge. The conveyor belt can further include a plurality of spaced apart teeth. The conveyor may also include a brush seal for preventing material from entering space under said first roller.

According to an embodiment of the present invention, the transport device includes a trailer. The transport device may further include any number of axles appropriate for supporting the weight of the payload. According to another embodiment of the present invention, the transport device may include a vehicle, such as a truck.

According to an alternative embodiment of the present invention, a combination seed carrier for carrying a plurality of disparate seed containers includes a common frame having a base, at least one support member and at least one coupling means for fixedly receiving a plurality of disparate seed containers such that seed can be discharged from the seed containers into a conveyor. The conveyor has an intake and a discharge. The conveyor is pivotably coupled to the common frame such that the intake can be positioned below the seed container output for receiving seed from containers.

### BRIEF DESCRIPTION OF THE DRAWINGS

Further applications and advantages of various embodiments of the present invention are discussed below with reference to the drawing figures.

FIG. 1 is a computer drawing of a perspective view of two combination seed carriers according to an embodiment of the present invention.

FIG. 2 is a computer drawing of a perspective view of a combination seed carrier coupled with a bulk hopper according to an embodiment of the present invention.

FIG. 3 is a computer drawing of a top view of a combination seed carrier coupled with a pro set of a plurality of pro-boxes according to an embodiment of the present invention.

FIG. 4 is a perspective view of the common frame of a combination seed carrier according to an embodiment of the present invention.

FIG. 5 is a top view of the common frame of a combination seed carrier according to an embodiment of the present invention.

FIG. 6 is a view of a seed carrier in an unloading position according to an embodiment of the present invention.

FIG. 7 is a view of a seed carrier in a loading position according to an embodiment of the present invention.

FIG. 8 is a view of a base system for the seed carrier according to an embodiment of the present invention.

FIG. 9 is a view of a lever mechanism for the base system according to an embodiment of the present invention.

FIG. 10 is a view of a seed carrier in a transport position according to an embodiment of the present invention.

FIG. 11 is a view of a belt conveyor for the seed carrier according to an embodiment of the present invention.

FIG. 12 is a view of the discharge end of a conveyor according to an embodiment of the present invention.

FIG. 13 is a forward view of a conveyor belt wrapping around a roller according to an embodiment of the present invention.

FIG. 14 is a view of the conveyor hopper in an unloading position according to an embodiment of the present invention.

FIG. 15 illustrates the receiving end of the conveyor according to one embodiment of the present invention.

FIG. 16 illustrates a perspective view a seed carrier according to an alternative embodiment of the present invention.

FIG. 17 illustrates a back view of a seed carrier according to an alternative embodiment of the present invention.

FIG. 18 illustrates a side view of an alternative embodiment of the present invention in which the common frame is coupled to a pro box hopper frame.

FIG. 19 illustrates a back view of an alternative embodiment of the present invention in which the pro box hopper frame is coupled to the common frame.

FIG. 20 illustrates a side view of an alternative embodiment of the present invention in which a bulk tank module is coupled to the common frame.

FIG. 21 illustrates a back view of an alternative embodiment of the present invention in which a bulk tank module is coupled to the common frame.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

In embodiments of the present invention, the novel seed carrier frame is configured to receive a number of known, different types of containers, tanks and hoppers into a common or central hopper that feeds a conveyor, thereby eliminating the need for specialized frames for each type of container, hopper, tank, etc. The following includes non-limiting examples of illustrative seeding equipment according to embodiments of the present invention. It should be appreciated that the following examples are provided for illustration and the present invention is not intended to be limited to the embodiments described herein.

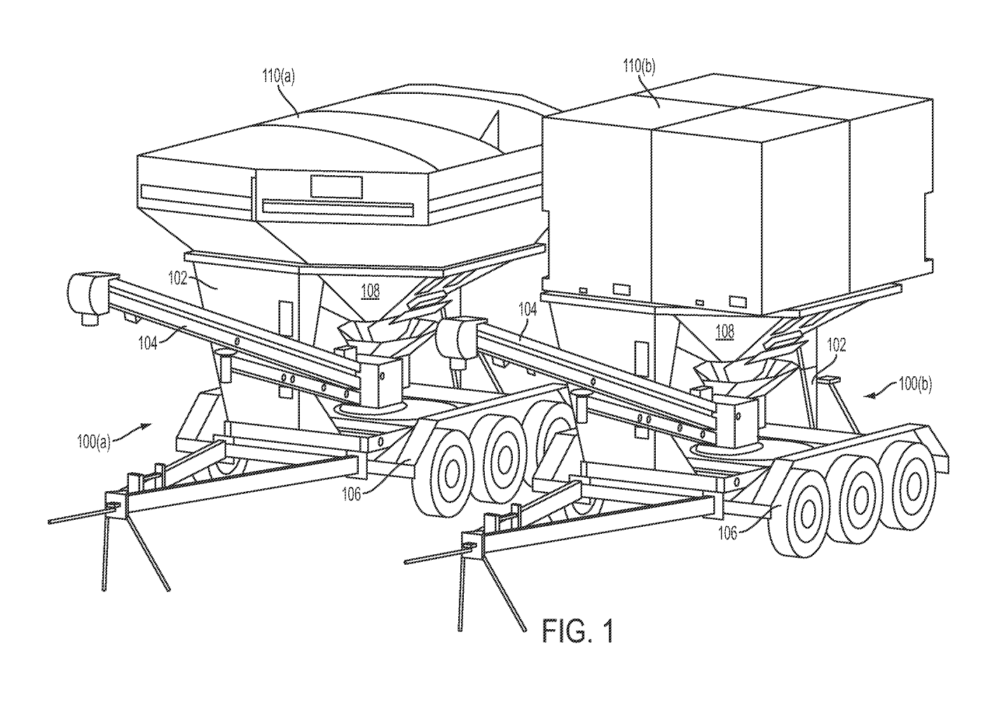

FIG. 1 illustrates combination bulk seed carriers 100(a) and 100(b) each configured to carry different kinds of seed containers, such as, but not limited to tanks, pro sets, pro-boxes, hoppers, etc. according to an embodiment of the present invention As shown, seed carrier 100(a) is coupled with a bulk tank 110(a) and seed carrier 100(b) is coupled with plurality of pro boxes 110(b).

Each seed carrier 100 may include a frame 102 supporting a common or central hopper 108, a conveyor 104, and transport means or device 106. The common frame 102 can be coupled to the conveyor 104. The transport device 106 can be fixedly coupled to the common frame 102. The common frame 102 can be configured to receive and support a plurality of different bulk seed container designs. As shown in FIG. 1, the common hopper 108 is configured to receive both a bulk tank 110(a) and pro boxes 110(b). As shown, the transport means 106 can be a trailer and the common frame 102 can be fixed to the trailer by conventions means (e.g., through bolts, etc.).

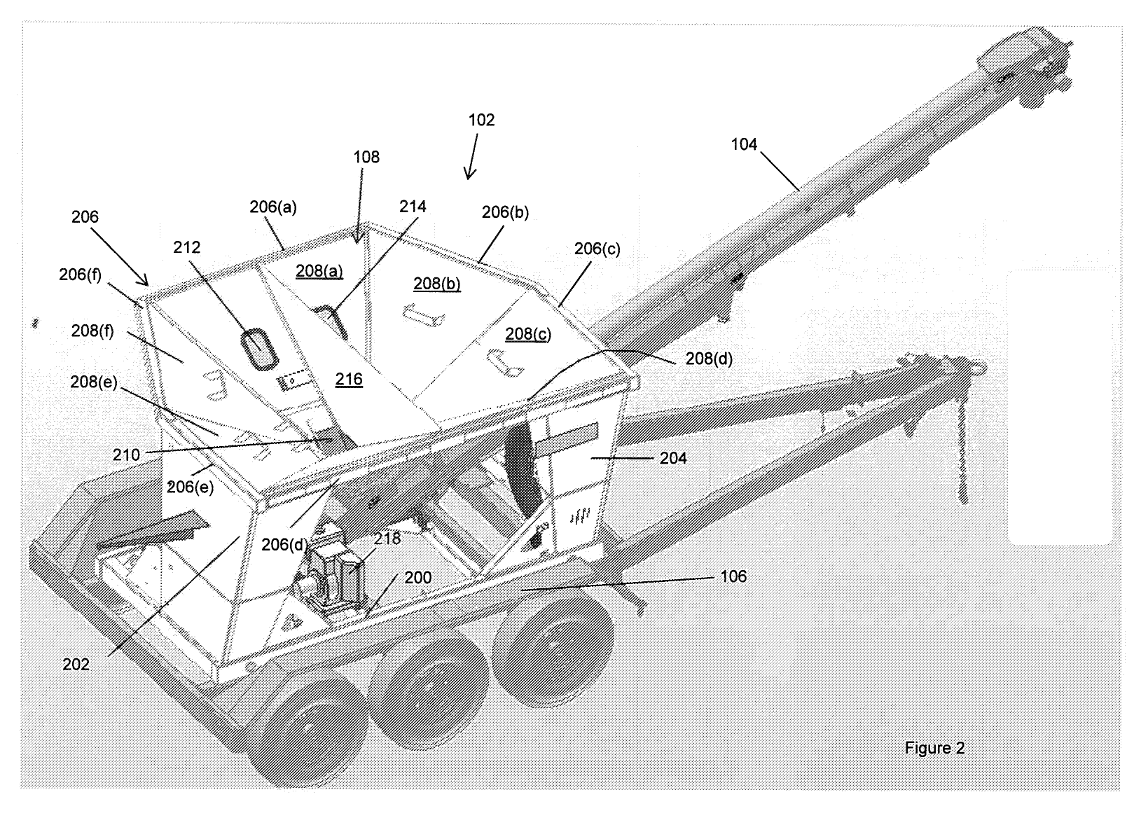

FIG. 2 is a perspective view of a combination seed carrier 100 before receiving any seed container, according to an embodiment of the present invention. As shown, the common frame 102 includes a base section 200, support members 202 and 204 and an upper tubular frame 206. The base 200 is coupled to the trailer 106. The base 200 is further coupled to the support members 202 and 204. In an embodiment of the present invention there may be more or less support members (e.g., one support member or three support members). The support members 202 and 204 are further coupled to and hold the common hopper 108. The common hopper 108 is configured to receive seed or other material from seed containers 110 (e.g., tanks, hoppers, pro-boxes, etc.). The tubular frame 206 extends about the circumference of the common hopper 108 and is configured to couple to seed containers 110. In an embodiment of the present invention, the tubular frame 206 may be coupled to seed containers 110 via bolts or clamps.

The common hopper 108 includes a number of inwardly facing inclined walls that feed material to a discharge end. The walls can be formed from metal panels or the like, which can be welded or otherwise secured. As shown, the common hopper 108 is formed from walls 208(a)-(f), an output 210, windows 212 and 214 and a divider 216. The walls 208(a)-(f) are inclined and inwardly facing so that seed received from the seed container 110 is channeled to the output 210. The output 210 discharges the seed to the conveyor 106 and may include a valve or doors. As shown, the common hopper 108 includes six walls 208(a)-(f). In another embodiment of the present invention, the common hopper 108 may include more or less walls or panels. The windows 212 and 214 are configured to allow the interior of the common hopper 108 to be visible from outside the common hopper 108. The divider 216 spans the interior of the common hopper 108 between two walls 408(a) and (d). According to an embodiment of the present invention, the divider 216 can act as a further support for seed carriers 110.

As shown, the tubular frame 206 includes frame members 206(a)-(f). Each frame member 206(a)-(f) is coupled to the top of the common hopper 108. In an embodiment of the present invention, there are as many frame members 206(a)-(f) as common hopper walls 208(a)-(f), and each member 206(a)-(f) is coupled to the top of a common hopper wall 208(a)-(f). In an embodiment of the present invention, each frame member 206(a)-(f) extends outwardly from the top of a common hopper wall 208(a)-(f) and spans at least the distance of the respective wall 208(a)-(f).

In an embodiment of the present invention, the tubular frame 206 includes two longitudinal members 206(a) and 206(d), two transverse members 206(c) and 206(e) and two angled members 206(b) and 206(f). The two longitudinal members 206(a) and 206(d) are parallel to one another. The two transverse members 206(c) and 206(e) are parallel to one another. Each angled member 206(b) and 206(f) extends between a longitudinal member 206(a) or 206(d) and a transverse member 206(c) or 206(e).

In an embodiment of the present invention, the first angled member 206(b) forms approximately a 115° angle with the first longitudinal member 206(a). The first angled member 206(b) forms approximately a 155° angle with the first transverse member 206(c). The second transverse member 206(c) forms approximately a 90° angle with the second longitudinal member 206(d). The second longitudinal member 206(d) forms approximately a 90° angle with the second transverse member 206(e). The second angled member 206(f) forms approximately a 155° angle with the second transverse member 206(e). The second angled member 206(f) forms approximately a 115° degree angle with the first longitudinal member 206(a).

The frame members 206(a)-(f) can be each substantially thick (e.g., approximately 2 inch) bars. In an embodiment of the present invention, the first longitudinal member 206(a) is approximately 106 inches (269.24 cm) long. The second longitudinal member 206(d) is approximately 65 inches (165.1 cm) long. The first and second transverse members 206(c) and 206(e) are approximately 44 inches (111.76 cm) long. The first and second angled members 206(b) and 206(f) are approximately 49 inches (124.46 cm) long. In another embodiment of the present invention, the tubular frame 206(a)-(f) members may be longer or shorter to accommodate main hoppers of varying size.

In an embodiment of the present invention, the seed carrier 100 includes a generator 218. The generator 218 may be used to supply power to the conveyor 104.

In a further embodiment of the present invention, the seed carrier include a weigh system (not shown) to provide the accurate weight of the amount of seed remaining. The weight system disclosed in U.S. Pat. No. 7,205,490, the entire disclosure of which is incorporated herein by reference, is an exemplary system that could be employed with the present invention.

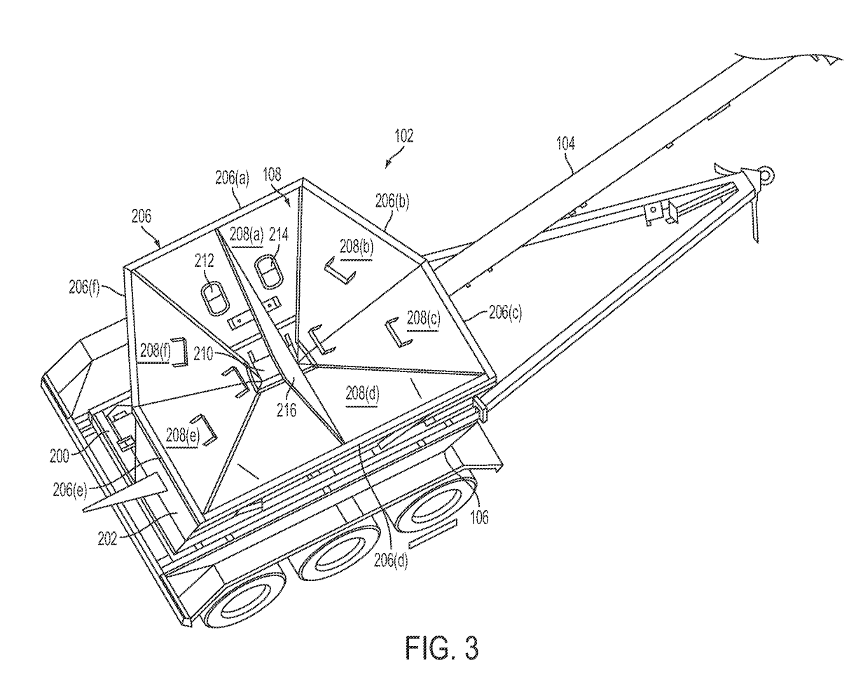

Referring to FIG. 3, a top view of a seed carrier 100 is illustrated without any seed containers loaded therein, according to an embodiment of the present invention. As can be better appreciated in FIG. 3, the common hopper walls 208(a)-(f) are all inwardly facing and inclined such that material received from seed carriers 110 is channeled to the common hopper discharge. Further, it will be appreciated that the divider 216 spans across the center of the common hopper 108.

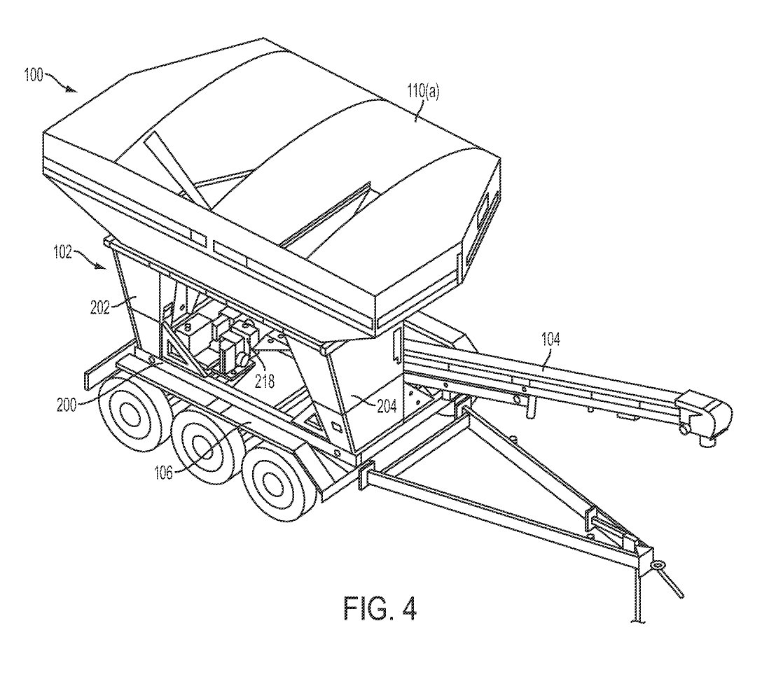

FIG. 4 illustrates a combination seed carrier 100 coupled with a bulk tank according to an embodiment of the present invention. The bulk tank 110(a) can be a large hopper that may be coupled to the common hopper 108 such that the contents of bulk tank 110(a) flow by gravity into the discharge area of the common hopper 108. Loading of the bulk tank is explained in further detail below.

As shown, common frame 102 includes a base 200 having support members 202 and 204. The base 200 is configured to couple to said transport device 106. The base is further coupled to the support members 202 and 204. The support members 202 and 204 are configured to support the seed container 110.

In an embodiment of the present invention, the bulk tank 110(a) is coupled to the common frame 102 by bolts or clamps. In another embodiment of the present invention, the bulk tank 110(a) has a built in frame (not shown) configured to be coupled to the common frame 102. The bulk tank frame is configured to abut the tubular frame 206 when the bulk tank 110(a) is supported. The bulk tank frame may then be coupled to the tubular frame 206 via bolts or clamps. The bulk tank 110(a) may come in various sizes to accommodate the needs of the customer (e.g., the bulk tank may have a capacity of 375 cubic feet to accept 300 bushels or a capacity of 275 cubic feet to accept 200 bushels).

As shown, the transport device 106 is a three axle, six-wheeled trailer that may be pulled by a vehicle, such as a truck or a tractor. In another embodiment of the present invention, the transport device 106 may be a trailer including more or less axles as need to support the weight. In another embodiment of the present invention, the transport device 106 may be other transportation means, such as a vehicle. For instance, the frame 102 could be fixed to the flat bed of an industrial truck. In a further embodiment of the present invention, the transport device 106 may include motors or any other drive means to perpetuate the seed carrier 100. The transport device 106 is capable of transporting the seed carrier 100 while supporting full main hoppers 108.

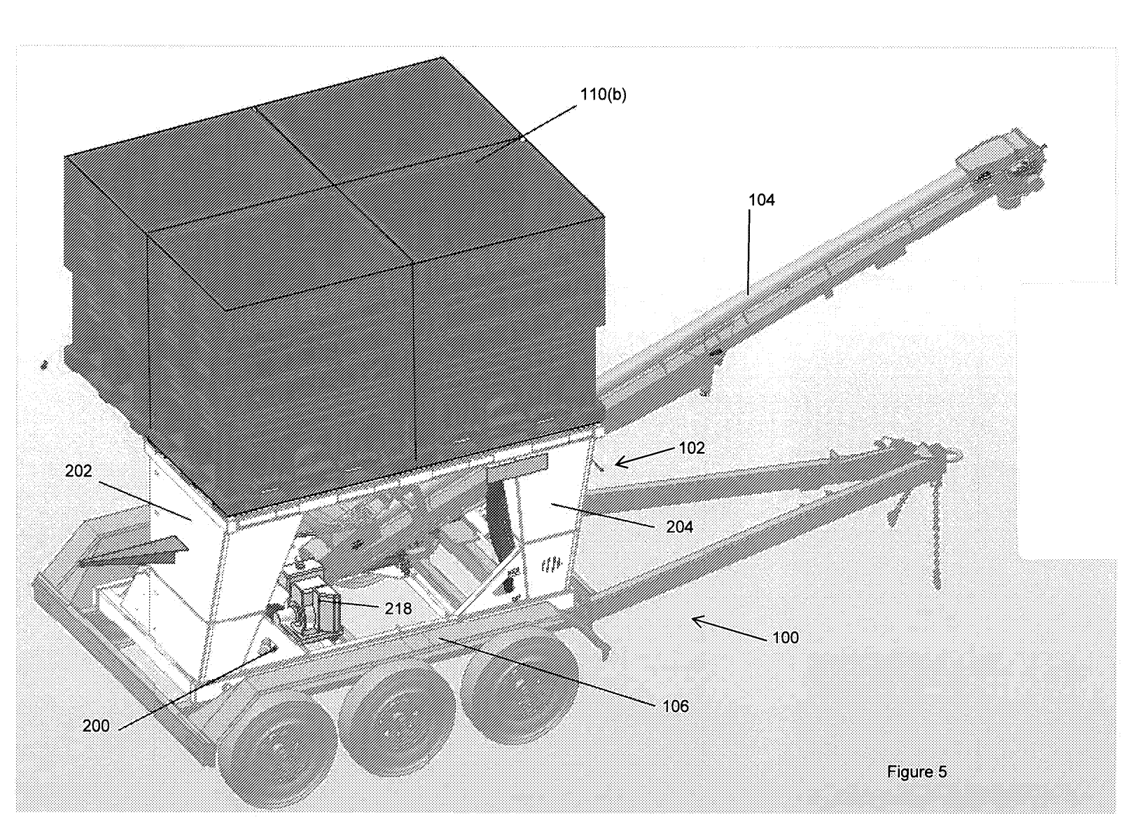

FIG. 5 illustrates a seed carrier 100 coupled with a plurality of pro boxes 110(b). Pro boxes 110(b) are containers pre-filled with material, such as seed, by the manufacturer or retailer. As shown, four pro boxes 110(b) are supported by the common frame 102. In another embodiment of the present invention, there may be more or less pro boxes 110(b) supported to the common frame 102. In an embodiment of the present invention, the pro boxes 108(a) may be coupled to the tubular frame 206 by bolts or clamps. In another embodiment of the present invention, the pro boxes 108(a) can be supported by a platform (not shown) that is capable of being coupled to the common frame 102. The platform can be coupled to the tubular frame 206 via bolts or clamps.

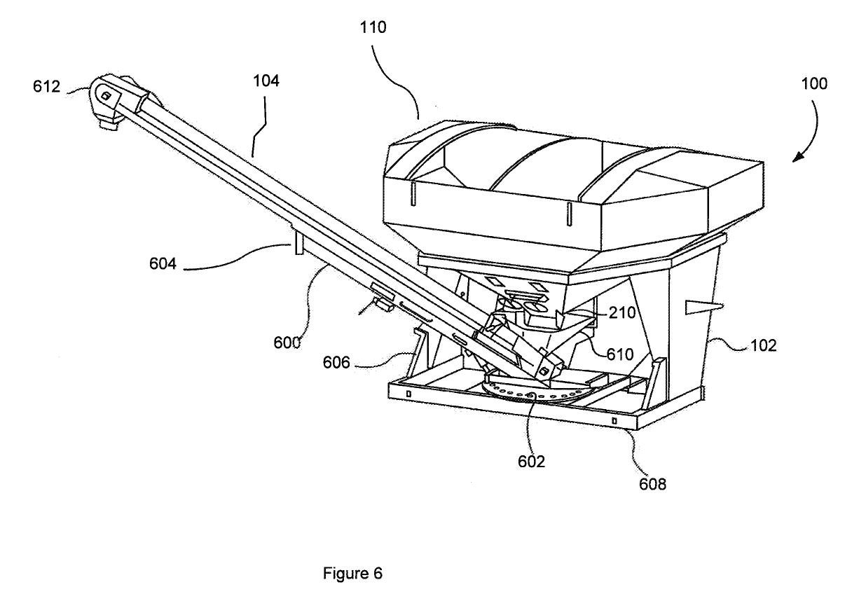

FIG. 6 is a view of a seed carrier in an unloading position according to an embodiment of the present invention. The seed carrier 100 includes a seed container 110 in the form of a bulk tank coupled to the common frame 102. A conveyor 104 is supported by a support arm 600 coupled with a pivoting mechanism 602 fixed to the common frame 102. The conveyor 104 is pivotably coupled with the support arm by a coupling 604 at a point that is preferably near or at the center of gravity of the conveyor 104. The conveyor 104 is also coupled to the support arm 600 by a latch (not shown) at the bottom of the conveyor. The latch allows the conveyor 104 to be uncoupled from the support arm 600 at the bottom so that the conveyor is free to rotate about the coupling 604. By positioning the coupling 604 at or near the center of gravity of the conveyor 104, the conveyor 104 balances on the pivoting coupling 604 such that little effort is required to rotate the conveyor 104.

The conveyor 104 can include a conveyor hopper 610 at its base, which is shown in the unloading position below the discharge of the common hopper 108. At the other end of the conveyor 104 is the conveyor discharge 612. Seed can be gravity fed from the seed container 110 into the common hopper 108, which in turn feeds the conveyor hopper or intake 610. The seed can then be moved to the discharge 612 of the conveyor 104 by an internal elevator or auger (not shown). In one embodiment, a motor-driven belt type elevator is coupled onto rollers at both ends of the conveyor.

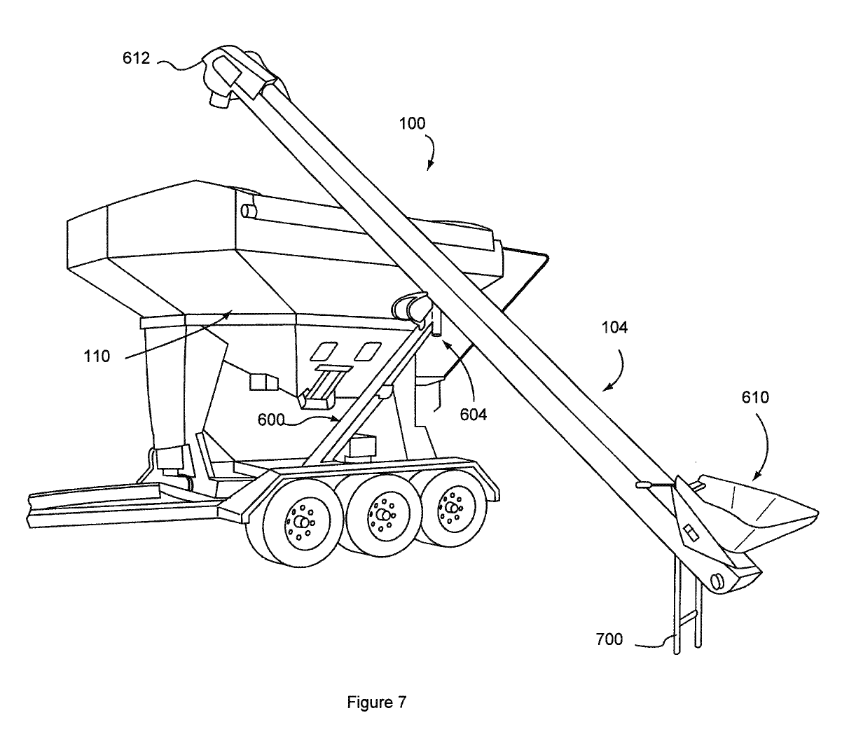

FIG. 7 illustrates the seed carrier 100 in a loading position. As shown, the conveyor 104 is uncoupled from the support arm 600 at its base and rotated 180 degrees about pivot coupling 604 so that the conveyor hopper 610 is positioned at a convenient location away from the carrier while the discharge 612 of the conveyor 104 is located over the seed container 110. A stand 700 is provided for holding the conveyor hopper 610 in place. The stand 700 may be integrated with the conveyor 104.

Accordingly, in the loading position, grain, seed or like can be feed into the conveyor hopper 610 to be moved to the discharge 612 for filling the seed containers 110 coupled to the common frame 102.

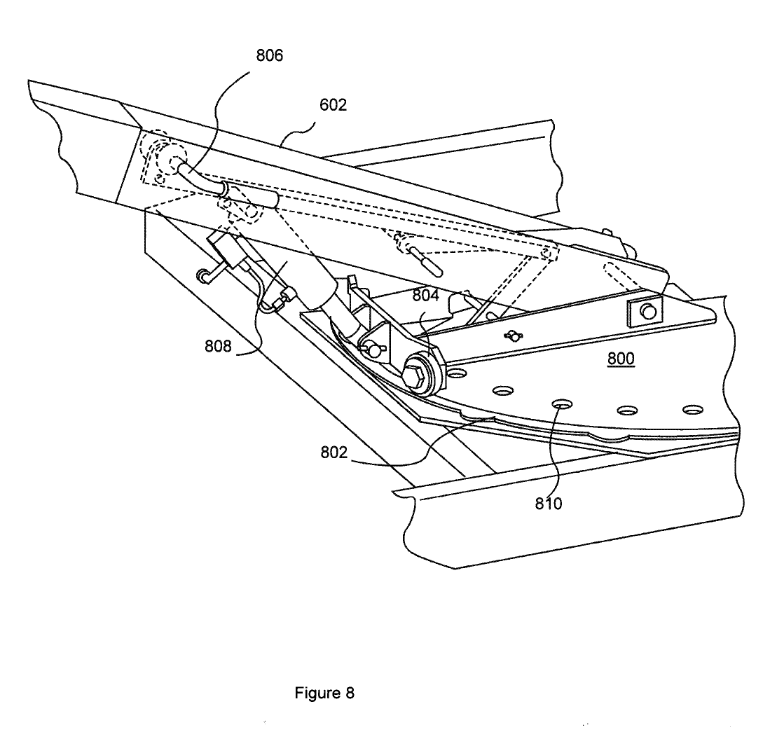

FIG. 8 is a view of the pivoting base of the support arm 600 for the conveyor. As shown, the support arm 600 can be pivotably coupled to a base 800 at a center point so that the support arm 600 is rotatable about a vertical axis. Wheels 804 provide support and can run along a track 802 to facilitate the support arm's 600 motion about the perimeter of the base 800. The support arm 600 can be locked into a selected position of the base 800 by engaging a pin (not shown) with one of a plurality of the holes 810 distributed around the base 800. The pin is disengaged with a hole by actuating a lever mechanism 806, which lifts the pin out of a hole. The lever mechanism 806 may be spring actuated to bias the pin toward the holes, so that simply releasing the lever will allow the pin to engage with one of the holes 810. Also shown, a hydraulic piston 808 is coupled with the support arm 600 for adjusting the height of the support arm 600.

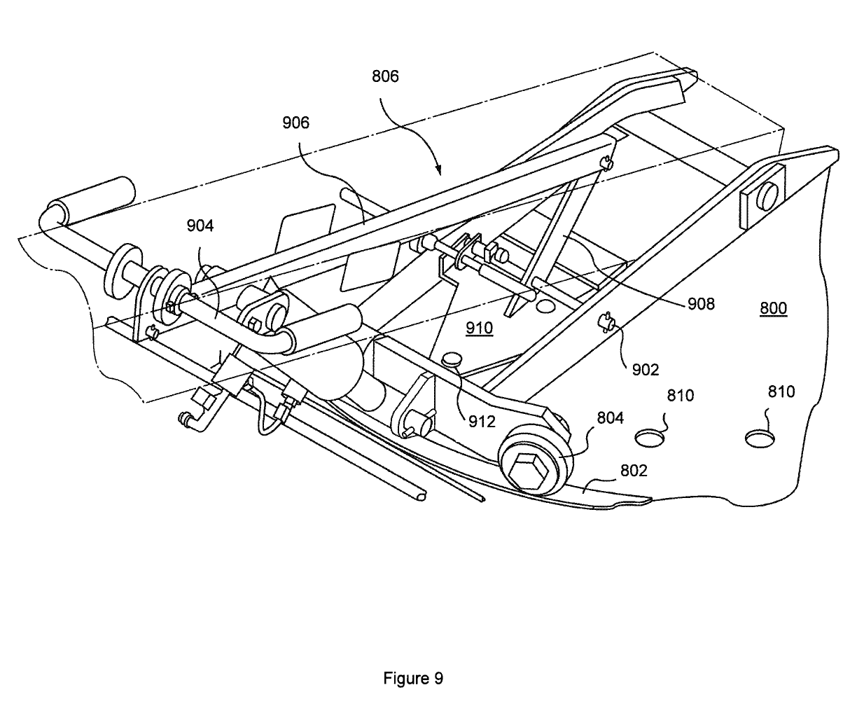

FIG. 9 is an alternative view of the support arm base. As shown, lever mechanism 806 includes a handle 904 coupled with a cross-bars 906 and 908. Cross-bar 908 is coupled to cross-bar 906 on one end and to a plate 910 having a pin 912 on the other end, and with a pivoting coupling 902 at a point near the plate. Rotating the handle 904 applies a downward force to crossbar 908 causing it to rotate about the coupling 902 to raise the plate 910 to disengage the pin 912. While disengaged, the base 800 is free to rotate about its vertical axis. Springs may be provided for biasing the pin 912 toward the holes 810 for engaging therewith, or the pin 912 can be engaged by gravity.

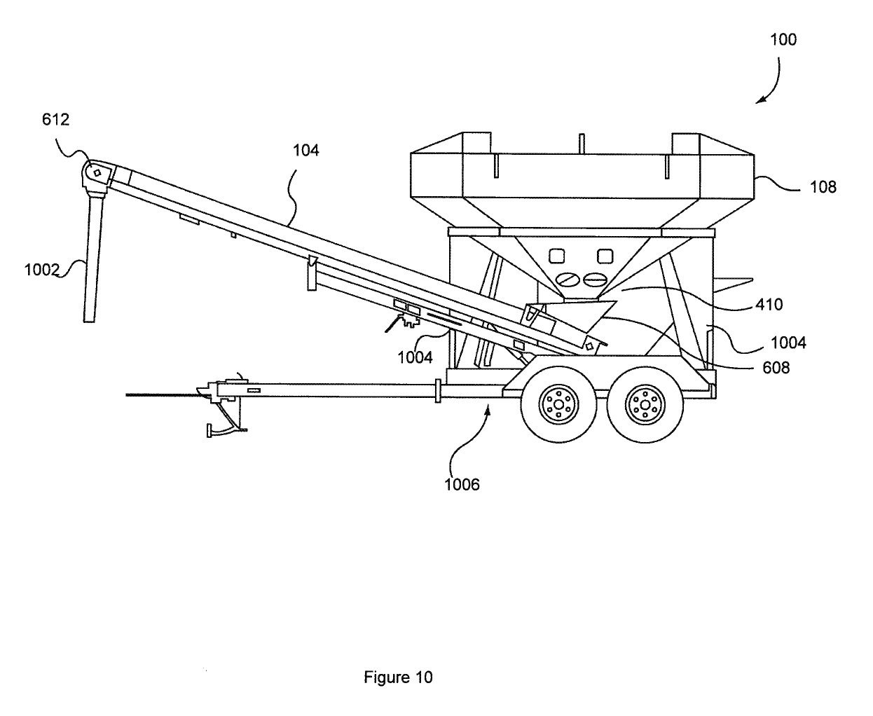

FIG. 10 is a side view of a seed carrier 100 according to an embodiment of the present invention. As shown in FIG. 10, the conveyor 104 includes an elongated discharge spout 1002 and is positioned in a transport position. Bracing members 1004 may be mounted on or integral with the support members 202 and 204 for holding the conveyor 104 in a forward transport position as shown, or a rearward transport position. As shown, the carrier 100 is fixed to a dual axle trailer 1006.

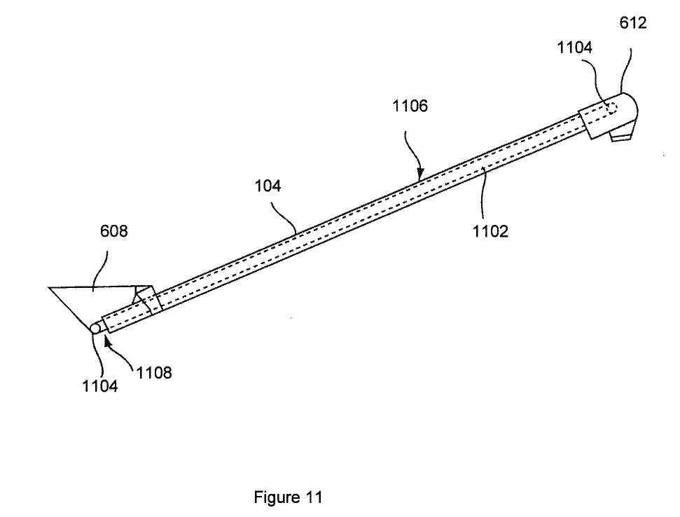

FIG. 11 illustrates a basic belt driven conveyor according to an embodiment of the present invention. The conveyor 104 comprises a belt 1102 that winds about a pair of rollers 1104. The rollers are positioned outside a tube section 1106, a first roller being positioned in the discharge 612 and a second roller being positioned below the conveyor hopper 610. A motor (not shown) or other means for turning the rollers may be provided at either end of the conveyor. A void 1108 exists below the rollers 1104 to allow the belt 1102 to travel on its return path.

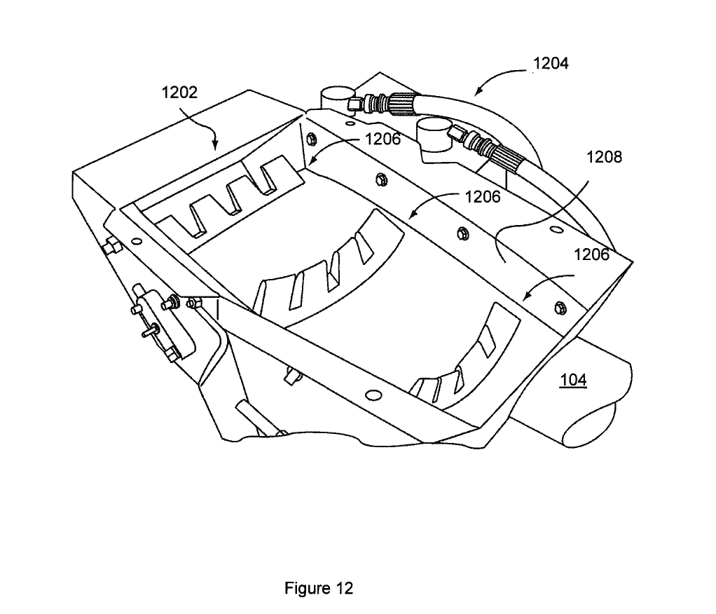

FIG. 12 is a view of a conveyor belt according to an embodiment of the present invention. The discharge end of a conveyor is shown where a conveyor belt wraps around a motor driven roller 1202. The motor may be a hydraulic motor and therefore, hydraulic hoses 1204 provide hydraulic fluid flow to and from the motor. Teeth 1206 are provided to push grain or seed up the conveyor. As shown, the conveyor belt is cupped in the tube section but flattens out as it reaches the roller 1202. Channeling members (seals) 1208 are provided on each side of the belt to form a seal and prevent grain or seed from falling off the edges of the belt as the belt begins to conform to the tubular portion of the conveyor 104.

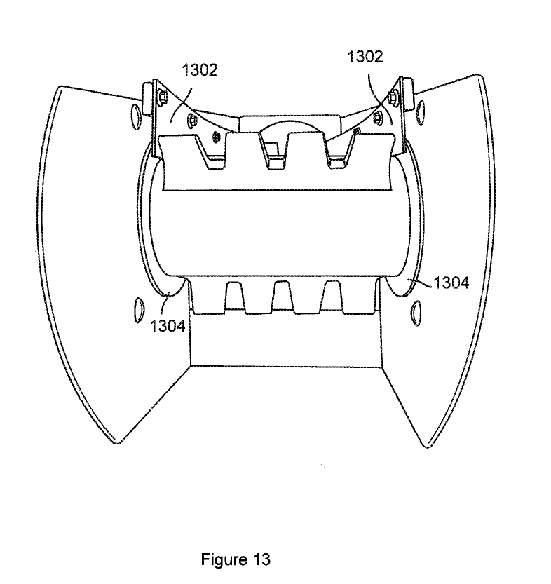

FIG. 13 is a front view of the belt as it travels over the roller 1202. Channeling members (seals) 1302 are provided on each side of the belt to form a seal and prevent grain or seed from falling off the edges of the belt as the belt flattens at the roller. As shown, the channeling members 1302 are fixed to the conveyor discharge 612 with bolts, but can be fixed by other means or can be integral with the discharge.

Discs 1304 are provided at the rollers at the edge of the belt to provide additional channeling/sealing means. The discs 1304 are preferably integral with the rollers or coupled therewith so that they may rotate.

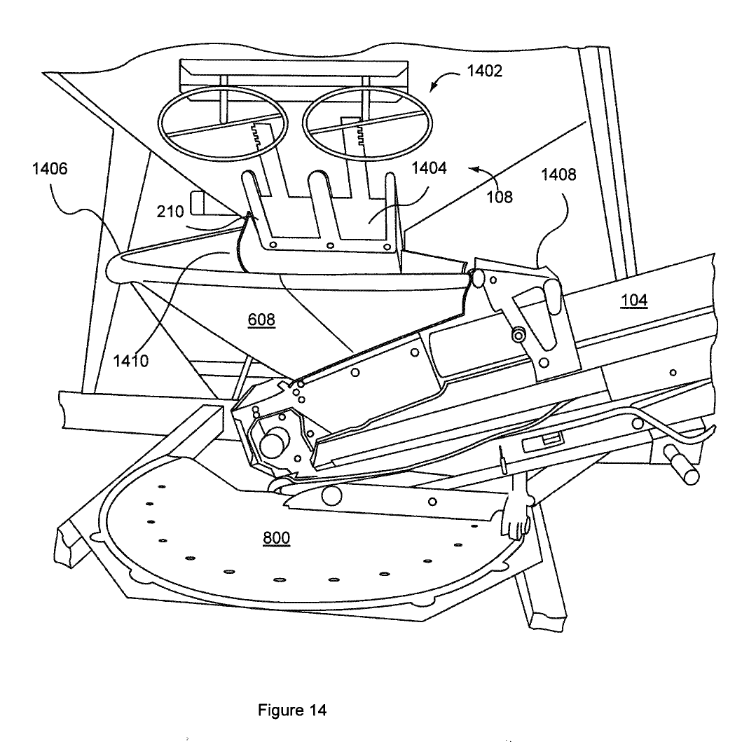

FIG. 14 is a side view of the hopper end (intake) of the conveyor 104. As shown, conveyor hopper 610 sits above in ingress to the conveyor 104. When coupled to the support arm 600, as shown, the conveyor hopper 610 is positioned below the common hopper output 210. The output 210 may be opened by conventional means. As shown, a wheel handle mechanism 1402 is provided for opening the discharge doors 1404.

The conveyor hopper 610 is preferably manufactured from light weight materials such as plastic, canvas, rubber or vinyl. As shown, the hopper 610 may include a mechanism for opening and closing the hopper. In this embodiment, flexible coupling or hinge is provided at one end 1406 of the hopper 610 and a mechanism 1408 is provided at the end of the hopper 610 and is coupled with the conveyor 104, such that the hopper 610 may be made to have an appropriate fit with the output 210. A flap 1410 can be provided at the bottom of the output 210.

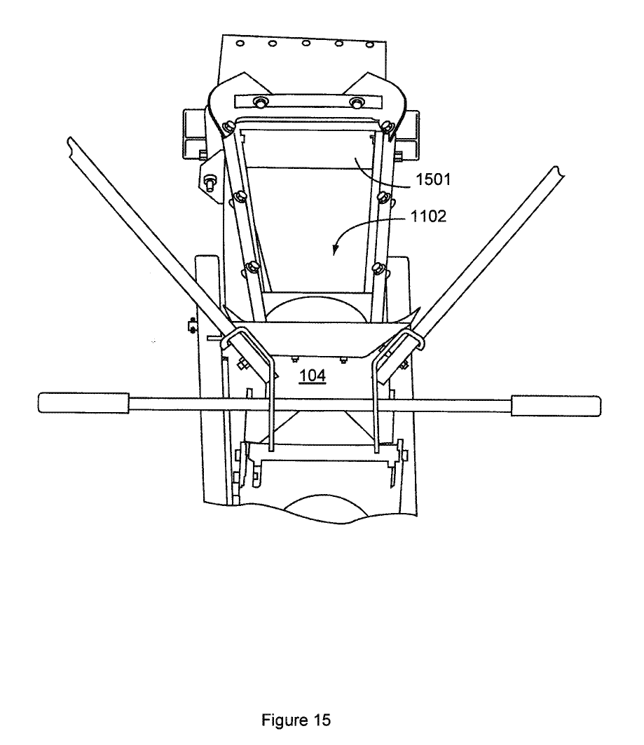

FIG. 15 is a schematic view of the hopper end of the conveyor. As is shown, a brush seal 1501 can be located across the belt 1102. The brush seal 1501 retains the conveyed material within the hopper and does not allow the material to enter the void 1108 (shown in FIG. 7) under the roller. Such an arrangement is desirable because it prevents the conveyed material from being subjected to mechanical agitation, which would result in damage to the conveyed material. The brush seal 1501 allows the conveyor teeth 1206 to pass, but not the conveyed material.

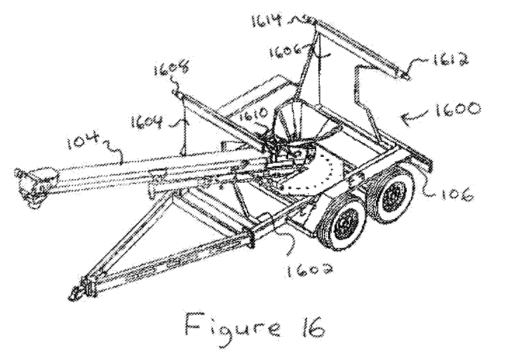

FIG. 16 illustrates a perspective view of a seed carrier according to an alternative embodiment of the present invention. In an alternative embodiment of the present invention, the seed carrier includes a conveyor 104, a transport means 106, and a common frame 1600. The common frame 1600 includes a base 1602, support members 1604, and 1606, and coupling means 1608, 1610, 1612, and 1614. The support members 1604 and 1606 are coupled or otherwise fixed to the base 1602. The support member 1604 and 1606 are configured to support a hopper or other containers above the base 1602. The coupling means 1608, 1610, 1612, and 1614 are fixed to the support members 1604 and 1606. The coupling means 1608, 1610, 1612, and 1614 are configured to allow a hopper or other containers to be coupled to the common frame 1600.

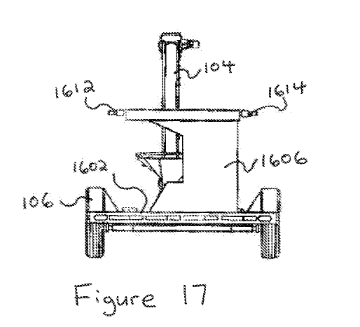

FIG. 17 illustrates a back view of a seed carrier according to an alternative embodiment of the present invention. As can be better appreciated from FIG. 17, the coupling means 1608 and 1610 are coupled to the top of the support member 1606. The coupling means 1608 and 1610 protrude outwardly from the support member 1606. According to embodiments of the present invention, the support members 1604 and 1606 are preferably shaped to both support the load of the hopper or other containers coupled thereto while allowing the conveyor 104 a wide range of rotation. For example, as shown, the left side of the support members includes cut out sections that provide for greater range of motion.

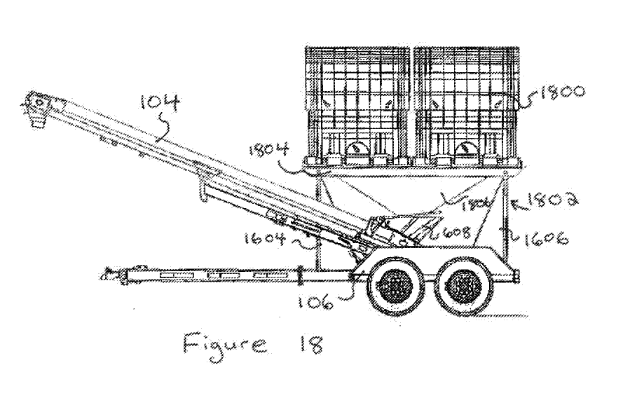

FIG. 18 illustrates a side view of an alternative embodiment of the present invention in which the common frame is coupled to a pro box hopper frame. The pro boxes 1800 are supported by a pro box hopper frame 1802. The pro box hopper frame 1802 includes a platform 1804 and a pro box hopper 1806. The platform 1804 is configured to support the pro boxes 1800 and coupled to the common frame 1600. The pro box hopper 1806 is configured to receive seed from the pro boxes 1800 and channel it to the conveyor 104, specifically the conveyor hopper 608.

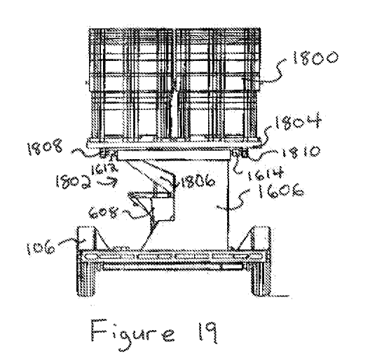

FIG. 19 illustrates a back view of an alternative embodiment of the present invention in which the pro box hopper frame is coupled to the common frame. As can be better appreciated from FIG. 19, the pro box common frame 1800 is coupled to the common frame 1600 via a pro box frame coupling means 1808 and 1810. The pro box coupling means 1808 and 1810 engage the common frame coupling means 1608 and 1610. In an embodiment of the present invention, the common frame coupling means 1608 and 1610 are male coupling means and the pro box coupling mans 1808 and 1810 are female coupling means. In an embodiment of the present invention, the pro box frame 1802 includes as many coupling means as the common frame 1600.

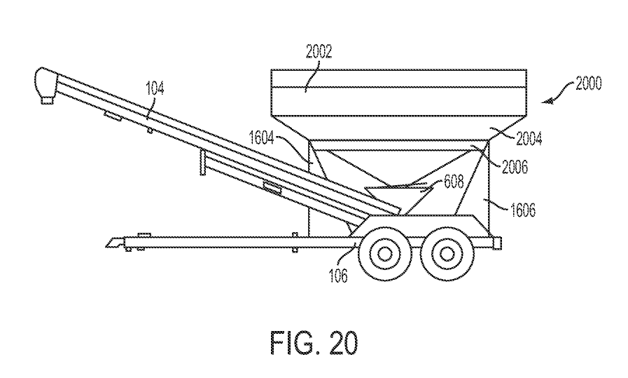

FIG. 20 illustrates a side view of an alternative embodiment of the present invention in which a bulk tank module is coupled to the common frame. The bulk tank module includes a bulk tank 2002 supported by a bulk tank hopper 2004 and a bulk tank frame 2006. The bulk tank hopper 2004 is configured to receive seed from the bulk tank 2002 and channel it to the intake of the conveyor 104, specifically the conveyor hopper 608. In an embodiment of the present invention, the bulk tank 2002 can be fixed to the bulk tank hopper 2004. The bulk tank frame 2006 is configured to couple to the common frame 1600. The bulk tank frame 2006 extends about the circumference of the bulk tank 2000. In an embodiment of the present invention, the bulk tank frame 2006 can be fixed to the bulk tank hopper 2004.

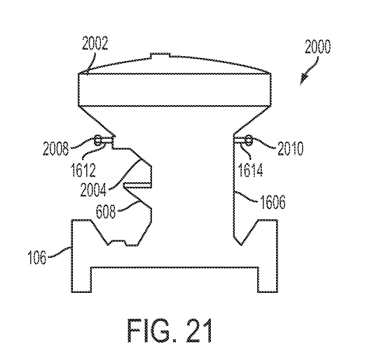

FIG. 21 illustrates a back view of an alternative embodiment of the present invention in which a bulk tank is coupled to the common frame. As can be better appreciated from FIG. 21, the bulk tank module 2000 is coupled to the common frame via bulk tank coupling means 2008 and 2010. In an embodiment of the present invention, the bulk tank module 2000 includes as many coupling means as the common frame 1600.

One will understand that hydraulic power can be provided by a towing vehicle, such as a tractor or the like or alternatively, hydraulic power can be provided on the tender and driving electrically from the towing vehicle, such as a truck.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

We claim:

1. A combination seed carrier for carrying a plurality of disparate seed containers, said seed carrier comprising:
a common frame capable of supporting a common hopper over a base, said base includes means for fixing said base to a transport device, said common hopper including a plurality of inwardly facing inclined walls for channeling seed to a discharge area, and fixtures positioned on said walls for fixedly receiving a plurality of disparate seed containers such that seed can be discharged from said seed containers into said common hopper; and
a conveyor having an intake and a discharge, said conveyor being pivotably coupled to said common frame such that said intake can be positioned below said common hopper output for receiving seed from said common hopper.

2. The combination seed carrier of claim 1, wherein said seed container is at least one pro box.

3. The combination seed carrier of claim 2, wherein said seed container is four pro boxes.

4. The combination seed carrier of claim 2, where said at least one pro box is supported by a platform capable of being coupled to said fixtures of the common hopper.

5. The combination seed carrier of claim 1, wherein said seed container is a bulk tank.

6. The combination seed carrier of claim 5, wherein said bulk tank further includes a circumferential frame capable of being coupled to said fixtures of the common hopper.

7. The combination seed carrier of claim 1, wherein said common hopper further includes a divider spanning between two of said inwardly facing inclined walls.

8. The combination seed carrier of claim 1, wherein said common hopper further includes a tubular frame fixed to the top of the common hopper, said tubular frame is capable of receiving a plurality of disparate main hoppers.

9. The combination seed carrier of claim 1, wherein said common frame further includes at least one support member coupling said common hopper to said base.

10. The combination seed carrier of claim 1, further comprising a weigh system capable of determining the weight of the main hopper.

11. The combination seed carrier of claim 1, further comprising a power system for said conveyor.

12. The combination seed carrier of claim 11, wherein said power system is a generator.

13. The combination seed carrier of claim 1, wherein said conveyor further includes a continuous flexible belt coupled to a first and a second roller and a tubular portion disposed between said intake and discharge.

14. The combination seed carrier of claim 13, wherein said conveyor further includes seal means for sealing edges of said conveyor belt at a point approximately where said conveyor belt meets at least one of said first and second rollers.

15. The combination seed carrier of claim 13, wherein said conveyor belt includes a plurality of spaced apart teeth.

16. The combination seed carrier of claim 13, wherein said intake of the conveyor further includes a brush seal for preventing material from entering space under said first roller.

17. The combination seed carrier of claim 1, wherein said transport device is a trailer including at least two wheels and capable of being pulled.

18. The combination seed carrier of claim 17, wherein said trailer includes six wheels.

19. The combination seed carrier of claim 1, wherein said transport device includes means for perpetuating said bulk seed carrier.

20. The combination seed carrier of claim 19, where said means for perpetuating said bulk seed carrier is a motor.

21. A combination seed carrier for carrying a plurality of disparate seed containers, said seed carrier comprising:
a common frame having a base, at least one support member and at least one coupling means for fixedly receiving a plurality of disparate seed containers such that seed can be discharged from said seed containers into a conveyor; and
a conveyor having an intake and a discharge, said conveyor being pivotably coupled to said common frame such that said intake can be positioned below said seed container output for receiving seed from containers.

22. The combination seed carrier of claim 21, wherein said seed container is a bulk tank module.

23. The combination seed carrier of claim 22, wherein said bulk tank module includes a bulk tank, a bulk tank hopper and a bulk tank frame capable of being coupled to said common frame coupling means.

24. The combination seed carrier of claim 21, wherein said seed container is at least one pro box.

25. The combination seed carrier of claim 24, wherein said at least one pro box is supported by a pro box frame.

26. The combination seed carrier of claim 25, wherein said pro box frame includes a platform and a pro box hopper.
